(19) United States
(12) Patent Application Publication
(10) Pub. No.: US 2011/0227983 A1
(43) Pub. Date: Sep. 22, 2011

(54) LIQUID EJECTING APPARATUS

(75) Inventor: Shigeki KANAI, Matsumoto (JP)

(73) Assignee: SEIKO EPSON CORPORATION, Tokyo (JP)

(21) Appl. No.: 13/037,674

(22) Filed: Mar. 1, 2011

(30) Foreign Application Priority Data
Mar. 16, 2010 (JP) 2010-059411

(51) Int. Cl. B41J 2/205

(52) U.S. Cl. 347/15

(57) ABSTRACT

The liquid ejecting apparatus is adapted to eject a waste ink from a liquid ejecting head, the waste ink H comprising color inks C, M, Y, K that have been discharged from a nozzle in a recovery operation serving to recover an ejection function of the nozzle. The apparatus includes a control device configured to use a conversion table determined based on quantity ratios of the color inks C, M, Y, and K making up the waste ink to convert image data into ejection data indicating quantities of the color inks C, M, Y, and K and the waste ink that should be ejected from the liquid ejecting head.

### CROSS-REFERENCE TO RELATED APPLICATIONS

This application claims priority to Japanese Patent Application No. 2010-059411 filed on Mar. 16, 2010. The entire disclosure of Japanese Patent Application No. 2010-059411 is hereby incorporated herein by reference.

### BACKGROUND

1. Technical Field

The present invention relates to a liquid ejecting apparatus, particularly a liquid ejecting apparatus configured to use waste liquid.

2. Related Art

There is a known liquid ejecting apparatus in which a liquid (e.g., ink) is supplied to a liquid ejecting unit (e.g., a liquid ejecting head) and ejected from a nozzle provided on the liquid ejecting head to a recording medium (e.g., paper) such that the liquid adheres to the recording medium as a recorded image (e.g., a character or a diagram). With this kind of liquid ejecting apparatus, a recovery process is executed in which a liquid remaining inside the nozzle is sucked out or forcefully pressured so as to be discharged, thereby recovering an ejection function enabling the liquid to be ejected from the nozzle. Japanese Laid-Open Patent Publication No. 2002-086763 and Japanese Laid-Open Patent Publication No. 2007-326229, for example, present technologies in which the liquid discharged during the recovery process (hereinafter called “waste liquid”) is directed to and collected in a tank and later supplied to the liquid ejecting head and ejected from the nozzle, thereby reusing the waste liquid.

Japanese Laid-Open Patent Publication No. 2002-086763 presents a technology that uses waste ink (waste liquid) effectively until a limit is reached beyond which the waste ink cannot be used due to degradation of its properties, and Japanese Laid-Open Patent Publication No. 2007-326229 presents a technology that uses waste ink having a higher viscosity by ejecting the waste ink (waste liquid) from a nozzle having a larger hole diameter.

### SUMMARY

Although the technologies proposed in Japanese Laid-Open Patent Publication No. 2002-086763 and Japanese Laid-Open Patent Publication No. 2007-326229 take into account the increased viscosity of waste ink, they do not take into account the color characteristics exhibited by the waste ink (e.g., hue and lightness). Furthermore, Japanese Laid-Open Patent Publication No. 2007-326229 mentions using the technology for a character printing mode in which image quality is not critically important, such as during draft printing. Thus, among liquid ejecting apparatuses configured such that they can reuse waste liquid, a remaining challenge has been to provide an apparatus that can form images in a manner that takes color characteristics into account when reusing waste liquid.

The present invention was conceived in order to meet the aforementioned challenge and its object is to provide a liquid ejecting apparatus that can form a high quality image even when a waste liquid is reused by taking color characteristics of the waste liquid into account.

In order to achieve the aforementioned object, a liquid ejecting apparatus according to the present invention comprises: a liquid ejecting unit provided with a nozzle and configured to eject a plurality of first liquids and a second liquid, the first liquids being color liquids having different colors and the second liquid being mixture of the first liquids; a memory section configured to store one conversion table or a plurality of conversion tables for converting image data into ejection data to be used by the liquid ejecting unit to eject the first liquids and/or the second liquid so as to form an image; and a converting section configured to use the conversion table to convert the image data into ejection data indicating quantities of the first liquids and the second liquid that should be ejected from the liquid ejecting unit. The conversion table(s) used by the converting section is determined based on a quantity ratio of the first liquids contained in the second liquid.

With this apparatus, since the image data is converted into ejection data using a conversion table that is tailored to the quantity ratios of the respective color liquids, i.e., first liquids, mixed in the second liquid, a second liquid that exhibits a color determined according to the quantity ratios of the respective color liquids can be used appropriately. As a result, even if a waste liquid comprising a previously discharged (waste) first liquid is used as the second liquid, a high quality image can be formed based on the image data by taking into account color characteristics of the second liquid.

In another aspect of a liquid ejecting apparatus according to the present invention, the memory section divides the quantity ratios of the first liquids contained in the second liquid into a plurality of ratio regions and stores one conversion table with respect to quantity ratios lying within each of the ratio regions.

For example, the quantity ratios of the color liquids contained in a waste first liquid are divided into ratio regions in each of which the quantity ratio one of the color liquids is higher than the quantity ratio of the other color liquids, and one conversion table is stored with respect to each of the ratio regions. In this way, the color exhibited by the waste liquid in each of the ratio regions is held to a similar range of color as a color exhibited by the color liquid having the highest quantity ratio. Thus, the number of conversion tables is suppressed and a waste liquid can be used appropriately in accordance with its color characteristics.

A liquid ejecting apparatus according to another aspect of the present invention further comprises a liquid quantity computing section configured to compute quantity ratios of the first liquids contained in the second liquid. In this aspect, the memory section is configured to store a discharged liquid quantity indicating a quantity of each of the first liquids discharged from the nozzle by a recovery operation configured to recover an ejection function of the nozzle and to store an ejected liquid quantity indicating a quantity of the second liquid ejected in accordance with the ejection data. The liquid quantity computing section acquires the discharged liquid quantities and the ejected liquid quantity stored in the memory section and computes quantity ratios of the first liquids contained in the second liquid. The converting section converts the image data into ejection data based on the computed quantity ratios using the stored conversion table.

The quantity ratios of the color liquids making up the first liquids contained in the second liquid change as images are formed and the recovery operation is executed. With this aspect of the invention, the second liquid can be used appropriately in accordance with its changing color characteristics by using conversion tables that reflect the changing quantity ratios of the color liquids making up the first liquids.

In a liquid ejecting apparatus according to another aspect of the present invention, the liquid quantity computing section is configured to compute quantity ratios of the first liquids contained in the second liquid when the color liquids making up the first liquids are discharged from the nozzle due to execution of the recovery operation.

The quantity ratios of the first color liquids making up the first liquids contained in the second liquid vary according to the quantities of liquid in the color liquids making up the first liquids discharged during the recovery operation. Therefore, the quantity ratios of the respective color liquids making up the first liquids are computed when the recovery operation has been executed. In this way, the waste liquid can be used appropriately in accordance with its color characteristics because the apparatus can use a conversion table corresponding to the changed color liquids, i.e., the discharged first liquids (waste liquid) whose quantity ratios have changed.

A liquid ejecting apparatus according to another aspect of the present invention further comprises a control section configured to execute a control based on ejection data obtained by converting image data such that the first liquids or the second liquid is ejected from the liquid ejecting unit. In this aspect, the liquid quantity computing section is configured to compute a remaining quantity of the second liquid by subtracting a total of the ejected liquid quantity from a total of the discharged liquid quantity stored in the memory section, and the control section is configured to execute a control such that the second liquid is not ejected from the liquid ejecting unit if the calculated remaining quantity of the second liquid is not equal to or larger than a threshold value.

With this aspect, degradation of an image quality caused by a supply of waste liquid being interrupted during ejecting can be prevented because waste liquid is not used for ejecting when, for example, there is a deficiency of waste first liquids.

### BRIEF DESCRIPTION OF THE DRAWINGS

Referring now to the attached drawings which form a part of this original disclosure:

FIG. 1 is a schematic view of a liquid ejecting apparatus according to an embodiment.

FIG. 2 is a system block diagram of a control device.

FIG. 3A is used to explain a conversion table for normal ink only and FIG. 3B is used to explain a conversion table for a case in which waste ink is included.

FIG. 4 is a flowchart for calculating a waste ink quantity.

FIG. 5 is a flowchart showing processing executed to use waste ink during print processing.

FIGS. 6A shows a pictorial view depicting ratio regions the quantity ratios of color inks and FIG. 6B shows an illustration of conversion tables stored in accordance with the quantity ratios of each o the color inks.

### DETAILED DESCRIPTION OF EXEMPLARY EMBODIMENTS

The present invention will now be explained in terms of a concrete embodiment of a liquid ejecting apparatus configured to record, i.e., print, an image on printer paper serving as a recording medium by ejecting a liquid, i.e., ink, onto the paper. The recording medium is not limited to printer paper (paper); it is acceptable for the recording medium to be a substrate or made of glass, metal, resin, cloth, or other material.

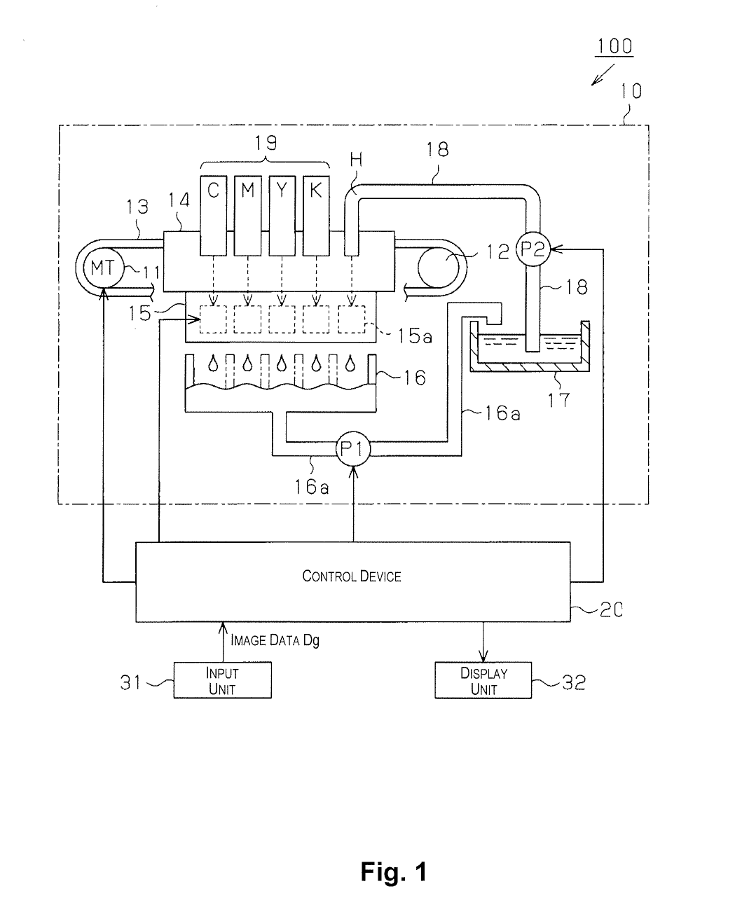

FIG. 1 is a schematic view of a liquid ejecting apparatus 100 according to this embodiment. As shown in the figure, the liquid ejecting apparatus 100 comprises a liquid ejecting mechanism 10 and a control device 20. The liquid ejecting mechanism 10 includes a carriage 14 equipped with a liquid ejecting head (hereinafter called simply “head”) 15 serving a s a liquid ejecting unit, a drive pulley 11 serving as a drive rotary body, and a driven pulley 12 serving as a driven rotary body. The drive pulley 11 is fixed to a rotary shaft of a carriage motor MT serving as a drive means such that the drive pulley 11 rotates as a unit with the carriage motor MT. A belt (endless belt) 13 is installed across the drive pulley 11 and the driven pulley 12 to transmit rotation of the drive pulley 11.

The carriage 14 is fixed to a portion of the belt 13 through a fastening section (not shown) provided on a portion of the carriage 14. The carriage 14 is guided by a guide shaft or the like (not shown) such that it can be moved in a prescribed direction (left and right direction in the figures) by the belt 13, which moves when the drive pulley 11 rotates as a unit with the carriage motor.

Ink cartridges 19 are detachably mounted on the carriage 14. The ink cartridges 19 serve to supply a color ink C (cyan), a color ink M (magenta), a color ink Y (yellow), and a color ink K (black) serving as first liquids made up of different color liquids to the carriage 14. A supply pipe 18 is also connected to the carriage 14 to supply a waste ink H serving as a second liquid (explained later). The color inks C, M, Y, K supplied from the ink cartridges 19 and the waste ink H supplied from the supply pipe 18 are conveyed to the head 15 through flow passages (not shown) provided inside the carriage 14.

In the explanation that follows, the simple terms “ink” and “inks” will be used when it is not necessary to distinguish among the color inks C, M, Y, and K and the waste ink H.

A head driving section 15a configured to pressurize the ink using an electrostrictive element is provided at an intermediate position along each of the flow passages of the head 15, and a row of nozzles corresponding to each of the inks is provided for ejecting the pressurized inks. Thus, the apparatus is configured to eject ink from the nozzles onto a sheet of printer paper arranged opposite a face of the head 15 in which the row of nozzles is formed. The apparatus is also configured such that the printer paper can be moved in a direction perpendicular to a movement direction of the carriage 14 as necessary.

There are times when an ink will not eject properly from a nozzle of the liquid ejecting apparatus 100 due to such causes as air bubbles residing in the ink or an increased viscosity (thickening) of the ink. Therefore, an ejection function recovery operation is executed before printing is started, after printing has ended, or in response to a command issued by a user of the liquid ejecting apparatus 100. The recovery operation involves a flushing process in which ink is discharged from the nozzle or a sucking process in which ink is sucked from the nozzle of the liquid ejecting apparatus 100.

More specifically, in the recovery operation, the carriage 14 is moved such that the head 15 is positioned as shown in the figure, i.e., facing opposite an ink cap 16 that serves to capture inks that have been discharged. The ink cap 16 is mechanically configured to contact the face of the head 15 in which the nozzles are formed in response to the movement of the carriage 14. If the recovery operation is a suction process, then the ink cap 16 contacts against the face of the head 15 in which the nozzles are formed so as to form a substantially airtight space and the space is drawn to a negative pressure by operating a pump P1. In this way, ink is drawn from the nozzles by a suction force resulting from the negative pressure, thereby removing ink containing air bubbles and thickened ink and recovering the ejection function. Meanwhile, if the recovery operation is a flushing process, then the head driving sections 15a pressurize the inks and discharge the inks by ejecting them from the nozzles into the ink cap 16. In this way, ink containing air bubbles and thickened ink are discharged from the nozzles and removed such that the ejection function is recovered.

The inks discharged into the ink cap 16 are pumped through a flow passage pipe 16a that is formed as an integral part of the ink cap 16 or connected to the ink cap 16 as a separate entity and stored in a waste ink tank 17 as waste ink H. Thus, the waste ink H is produced by the recovery operation. The waste ink H stored in the waste ink tank 17 is supplied from the waste ink tank 17 to the carriage 14 as a second liquid by being pumped through the supply pipe 18 connected to the carriage 14 using a pump P2 arranged at an intermediate position along the supply pipe 18. In this way, the apparatus is configured to reuse the waste ink H.

With this embodiment, it is possible to adopt either a configuration in which ink is sucked from all of the nozzles simultaneously or configuration in which ink is collected independently from the nozzles corresponding to each of the inks by sealing an individual nozzle and applying suction, as indicated with a double-dot chain line in the figure. When an independent suction scheme is adopted, a plurality of ink caps are placed against the face of the head in which the nozzles are formed in positions corresponding to each of the color inks, respectively, so as to form independent substantially airtight space. Then, a negative pressure state is created selectively with respect to the substantially airtight spaces by operating the pump P1 and opening and closing valves (not shown), and ink is drawn out of the nozzle(s) selected to be treated with the recovery operation. The inks drawn out in this way are conveyed from the respective ink caps to the waste ink tank 17 and stored. With independent suction, it is also acceptable to execute suction of only the black ink K independently from section of the color inks C, M, and Y.

The carrier motor MT, the head driving sections 15a, and the pumps P1 and P2 are controlled by the control device 20 provided in the liquid ejecting apparatus 100. The control apparatus 20 is configured to receive and store data transmitted from an input unit 31 and to display necessary data on a display unit 32. The input unit 31 is, for example, a keyboard, a mouse, a USB memory, a CD ROM, or a DVD ROM, and the control device 20 receives necessary data through an input terminal or input device that is compatible with the input unit 31. The display unit 32 is a liquid crystal display panel, a CRT, an EL panel, or the like, and the control device 20 outputs (displays) the necessary data through an output terminal or output device that is compatible with the display unit 32.

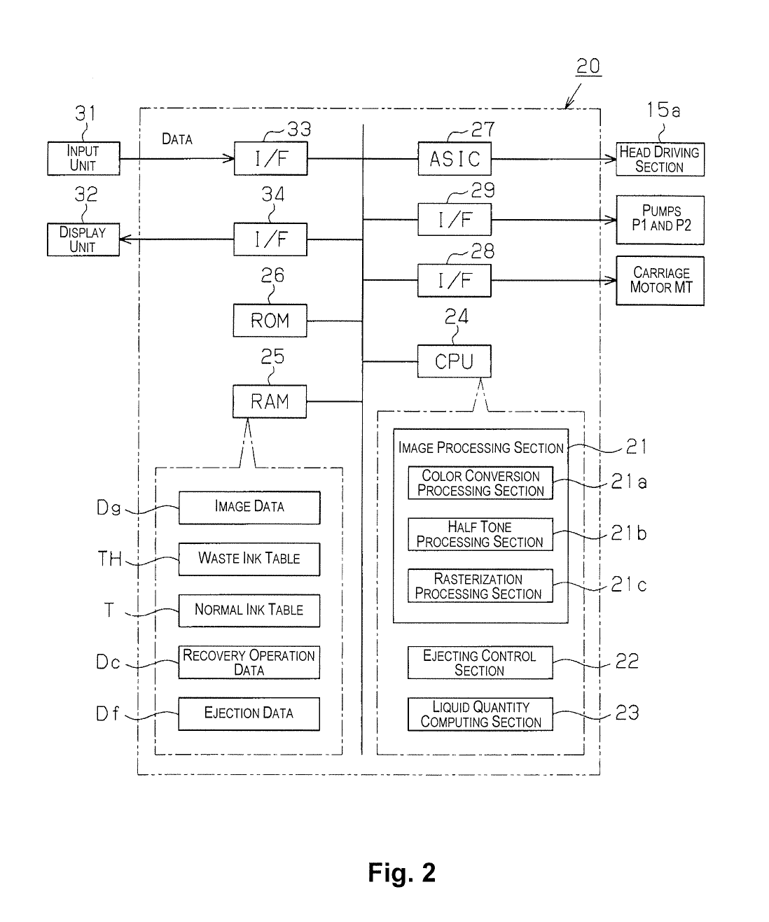

The constituent features of the control device 20 will now be explained in detail with reference to FIG. 2. The control device 20 is an electric circuit comprising such electronic components as a CPU (central processing unit) 24, a RAM (random access memory) 25, a ROM (read only memory) 26, and an ASIC (integrated circuit) 27 mounted on a substrate (not shown). If necessary, the control device 20 also has another electric circuit comprising I/Fs (interfaces) 28, 29, 33, and 34 that include driver circuits.

By means of the CPU 24 executing programs stored in the ROM 26 and the operation of the hardware circuits, the control device 20 controls each of the electric circuits and functions as an image processing section 21, an ejecting control section 22, and a liquid quantity computing section 23. The functions of each of the sections will now be explained.

The image processing section 21 comprises a color conversion processing section 21a, a half tone processing section 21b, and a rasterization processing section 21c. Image data Dg is received from the input unit 31 through the I/F 33 and stored in the RAM 25 (memory section). The image processing section 21 converts the image data Dg into ejection data Df indicating liquid quantities of each of the color inks C, M, Y, and K and the waste ink H that should be ejected from the head 15 as well as ejecting timings for each of the inks. The image processing section 21 thus functions as a converting section.

In this embodiment, the image data Dg comprises color values ranging from 0 to 255 for each of the colors R (red), G (green), and blue (B) in an 8-bit format compatible with the sRGB standard. The color conversion processing section 21a of the image processing section 21 converts the R, G, and B image data (hereinafter called “RGB data”) into data indicating ejection quantities of the color inks C, M, Y, and K and the waste ink H using a lookup table (LUT) serving as a conversion table.

A waste ink table TH (hereinafter called simply a “table TH”) and a normal ink table T (hereinafter called simply a “table T”) are stored in the RAM 25 as the conversion table used for this color conversion. The table TH is a conversion table used when all of the inks, including the waste ink H, will be used, and the table T is a conversion table used when only the color inks C, M, Y, and K will be used and not the waste ink H. In this embodiment, since a discharge quantity (ejection quantity) of each of the inks used in the liquid ejecting apparatus 100 depends on the shapes of the nozzles as explained previously, the data of the table T and the table TH are acquired from, for example, a host computer through the input unit 31 and stored for each particular apparatus. If there will not be any difference in the discharge quantities (ejection quantities) of the inks used in different liquid ejecting apparatuses 100, then it is acceptable to store a table T and a table TH in the ROM 26 in advance.

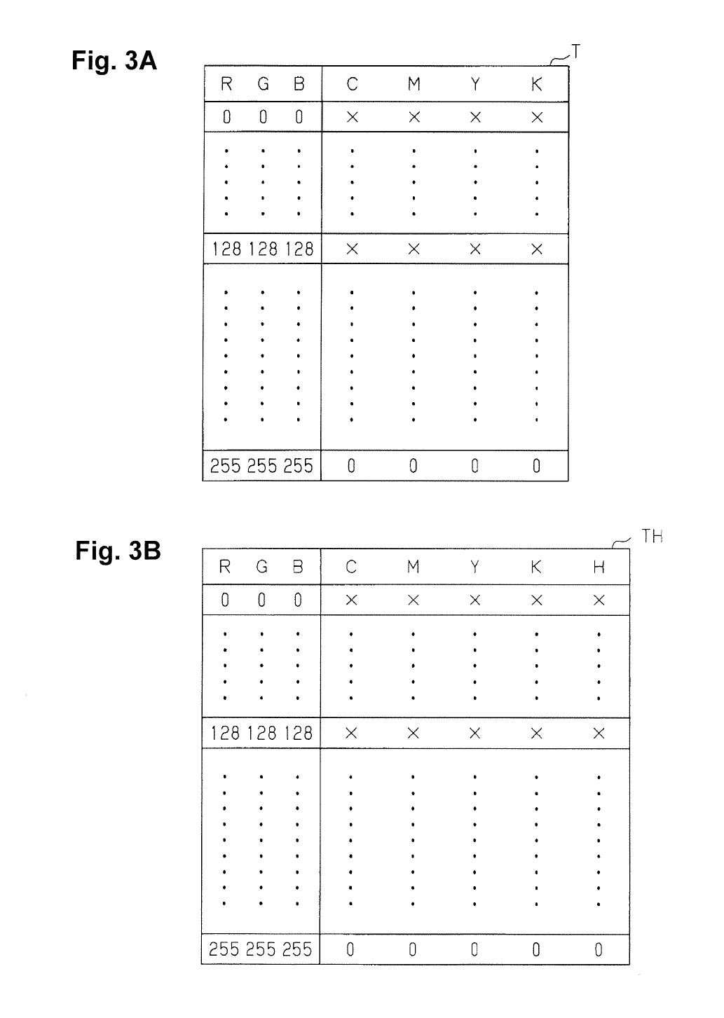

FIGS. 3A and 3B show examples of the conversion tables stored. FIG. 3A shows a table T and FIG. 3B shows a table TH. The RGB data in the tables is color value data expressed in terms of 256 color values (8-bit) for each color, and a value range of each of the color components is divided by 16 to establish a total of 17 to the third power reference points. In the table T, each of the color inks C, M, Y, and K is specified by color value data (called “CMYK data”) in terms of the values 0 to 255 in correspondence to the reference points, and the CMYK data based on the RGB data is referenced to accomplish the color conversion. Meanwhile, in the table TH, in addition to the CMYK data, the waste ink II is specified by color value data in terms of the values 0 to 255 in correspondence to the reference points, and the CMYK data and H data based on the RGB data (referred to collectively as “CMYKH data”) is referenced to accomplish the color conversion. In this embodiment, a plurality of tables TH are prepared in accordance with different quantity ratios of the color inks C, M, Y, and K contained in the waste ink H. These tables TH will be explained later.

When using the table T or the tables TH, RGB data that does not coincide with a reference point is converted into CMYK data or CMYKH data by executing an interpolation computation based on the RGB data of a reference point that is positioned nearby. It is acceptable for the RGB data, the CMYK data, and the H data to have a bit count higher than eight bits in order to improve precision or lower than eight bits in order to save memory. It is also acceptable to divide the value ranges of the color components in such a fashion as to obtain a larger number of reference points or, conversely, a smaller number of reference points.

Returning to FIG. 2, after the color conversion, the halftone processing section 21b and the rasterization processing section 21c execute halftone processing and rasterization processing to produce ejection data Df. The halftone processing and the rasterization processing are well-known processing schemes whereby the CMYK data or CMYKH data obtained from the color conversion are converted into two-value, four-value data, or the like (i.e., data indicating liquid quantities to be ejected) based on the type of dots to be formed by the ejection operation, and the rasterization processing also includes a well-known processing scheme for converting to data that includes ejecting timings corresponding to a movement of the carriage 14.

The ejecting control section 22 functions as a control section by operating (rotating) the carriage motor MT through the I/F 28, operating the head drive sections 15a through the ASIC 27, and ejecting each of the inks from the respective nozzles at timings and quantities specified by the ejection data Df. Meanwhile, the ejecting control section 22 controls (drives) the pump P2 through the I/F 29 to supply waste ink H to the carriage in a reliable fashion. The ejecting control section 22 also stores the ejection data Df, i.e., the quantities of each ink to be ejected, in the RAM 25.

Additionally, the ejecting control section 22 is configured to execute a recovery operation at predetermined timings, such as when ejecting based on ejection data Df is started, and when command data is received from the input unit 31. If the recovery operation is configured to be a suction process, then the ejection control section 22 executes control through the I/F 28 to move the carriage 14 to a position facing opposite the ink cap 16 and drives the pump P1 through the I/F 29, thereby sucking ink from the nozzles of the head 15 to the ink cap 16 arranged contacting the head 15. If the recovery operation is configured to be a suction process, then the ejection control section 22 executes control through the I/F 28 to move the carriage 14 to a position facing opposite the ink cap 16 and drives the pump P1 through the I/F 27, thereby sucking ink from the nozzles of the head 15 to the ink cap 16 arranged contacting the head 15. The control device also stores in the RAM 25 a quantity of the inks discharged each time the recovery operation is executed as recovery operation data Dc.

The liquid quantity computing section 23 functions as a liquid quantity computing section by calculating quantity ratios of the respective color inks C, M, Y, and K contained in the waste ink H. It also calculates a difference between a quantity of the color inks C, M, Y, and K discharged during the recovery operation and a quantity of the waste ink H to be ejected based on the ejection data Df. That is, the liquid quantity computing section 23 acquires the recovery operation data Dc and the ejection data Df stored in the RAM 25 and calculates an amount (remaining liquid quantity) of the waste liquid H remaining in the liquid ejecting apparatus 100.

A recovery operation control and an ejecting operation control whereby ink is ejected based on ejection data Df and will now be explained as relates to a liquid ejecting apparatus 100 configured to reuse waste ink H. As explained previously, the recovery operation control serves to produce waste ink H and the ejecting operation control serves to consume the waste ink H. In this embodiment, these controls are executed by the image processing section 21 and the ejecting control section 22.

### Recovery Operation Processing

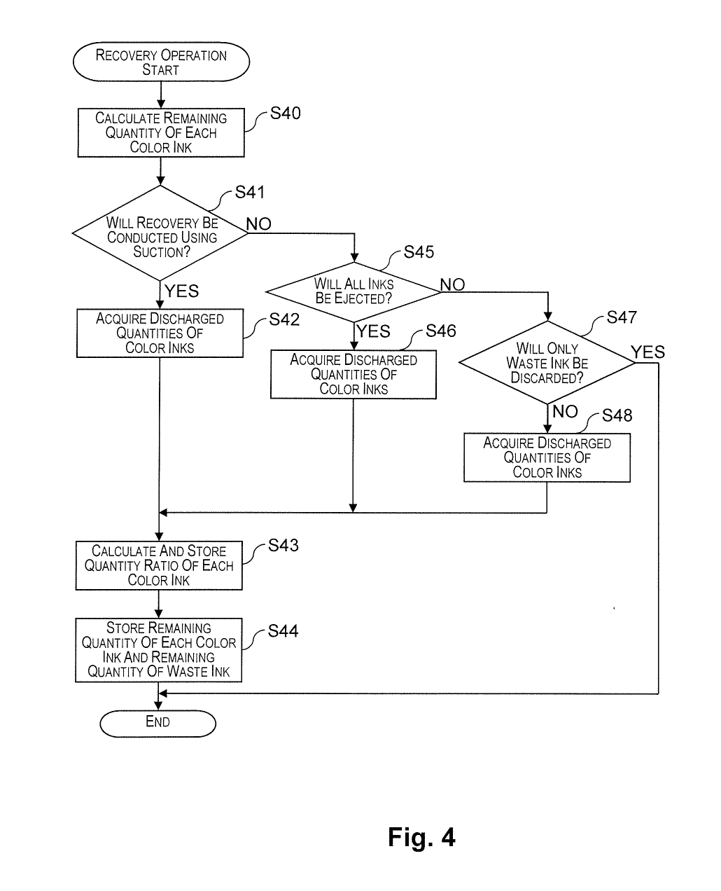

A recovery operation control processing will now be explained with reference to FIG. 4. First, in step S40 a remaining liquid quantity is calculated for each of the color inks in the waste ink. More specifically, values indicating a remaining amount (remaining liquid quantity) of each of the color inks that were stored in the RAM 25 in a step S44 (explained later) are read, a total quantity of waste ink H consumed by being ejected in accordance with ejection data Df since a previous execution of the recovery operation is acquired from the ejection data Df, and subtraction is executed to calculate the remaining liquid quantities. When the liquid ejecting apparatus 100 is first used and when a new waste ink tank 17 has been installed to replace an old one, the remaining quantity of waste ink H is zero and the individual quantities of the color inks C, M, Y, and K contained in the waste ink H are zero.

In step S41, a determination is made as to whether the current recovery operation will be executed using a suction process. In this embodiment, this step involves the liquid quantity computing section 23 using program data or command data received from an input unit to determine the type of recovery operation that will be executed by the ejecting control section 22. If the result of step S41 is Yes (i.e., if it is determined that the recovery operation will be conducted using suction), then the control device proceeds to step S42 and acquires a discharge quantity of each of the color inks.

For both simultaneous suction through all nozzles and independent suction through individual nozzles, the quantities of each of the color inks discharged during the suction process sometimes vary depending on such factors as unevenness of the suction pressure generated inside the ink cap 16, variation of the shapes of the nozzles, and the number of nozzles provided. In this embodiment, the quantities of the color inks C, M, Y, and K discharged from each of the nozzles during one suction process (either simultaneous suction or independent suction) are investigated in advance and discharge quantity data for the color inks C, M, Y, and K is stored in the RAM 25 as recovery operation data Dc. Thus, in step S42, the control device reads and acquires the stored recovery operation data Dc.

In step S43, the control device calculates quantity ratios for each of the color inks and stores the ratios. In this embodiment, the discharged quantities of each of the color inks C, M, Y, and K are added to the respective quantities of the color inks C, M, Y, and K remaining in the waste ink H calculated in step S40 and the resulting remaining liquid quantities are stored in the RAM 25. Afterwards, in step S44, the control device stores the calculated remaining quantities of the color inks C, M, Y, K and remaining quantity of the waste ink H in the RAM 25. The remaining quantity of the waste ink H equals the total sum of the individual remaining quantities of the color inks C, M, Y, and K and this total quantity is the amount of waste ink H that can be reused. Although it is omitted from this explanation, in a case where the recovery operation includes independent suction of the waste ink H alone, the waste ink H is merely circulated and the quantity and quantity ratio do not change. Therefore, no processing is executed.

Meanwhile, if the recovery operation is not a suction process but a flushing process (No), then the control device proceeds to step S45 and determines if all of the inks will be ejected. If the result of step S45 is Yes (i.e., if it is determined that the recovery operation will involve ejecting all of the inks), then the control device proceeds to step S46 and acquires a discharge quantity of each of the color inks. In this embodiment, the quantities of the color inks C, M, Y, and K discharged from each of the nozzles during one flushing process are investigated in advance and discharge quantity data for the color inks C, M, Y, and K is stored in the RAM 25 as recovery operation data Dc, similarly to when the recovery operation is a suction process. Thus, the liquid quantity computing section 23 reads and acquires the stored recovery operation data Dc. Then, the control device proceeds to step S43 where it calculates a quantity ratio of each of the color inks in the waste ink H and to step S44 where it stores a remaining quantity of each of the color inks in the waste ink H.

Meanwhile, if the result of step S45 is No (i.e., if it is determined that the recovery operation will not involve ejecting all of the inks), then the control device proceeds to step S47 and determines if only waste ink will be ejected. If the result of step S47 is Yes (i.e., if it is determined that only waste ink will be ejected), then the control device ends the control sequence because the quantity ratios of the individual color inks in the waste ink H and the total quantity of ink will not change. Meanwhile, if the result of step S47 is No (i.e., if it is determined that the recovery operation will not involve ejecting only waste ink), then the control device proceeds to step S48 and acquires a discharge quantity of the ejected color ink because the recovery operation is a selective flushing process in which a particular color ink is ejected. In this embodiment, the ink discharge quantity that is ejected (discharged) from a nozzle when a selective flushing process is executed once is investigated in advance for each of the color inks C, M, Y, and K and the discharged quantity data for each of the color inks is stored in the RAM 25 as recovery operation data Dc. Thus, the liquid quantity computing section 23 reads and acquires the stored recovery operation data Dc. Then in the same manner as explained previously, the control device proceeds to step S43 where it calculates a quantity ratio of each of the color inks C, M, Y, and K and to step S44 where it stores a remaining quantity of each of the color inks.

With the recovery operation processing explained above, the control device calculates a remaining quantity and a quantity ratio of each of the color inks C, M, Y, and K in the waste ink H. As a result, the since the ink color characteristics that will be exhibited by the waste ink H is known, the waste ink H can be used in accordance with image data during ejecting operation processing. In this embodiment, the color characteristics are hue and lightness, particularly hue.

### Ejecting Operation Control

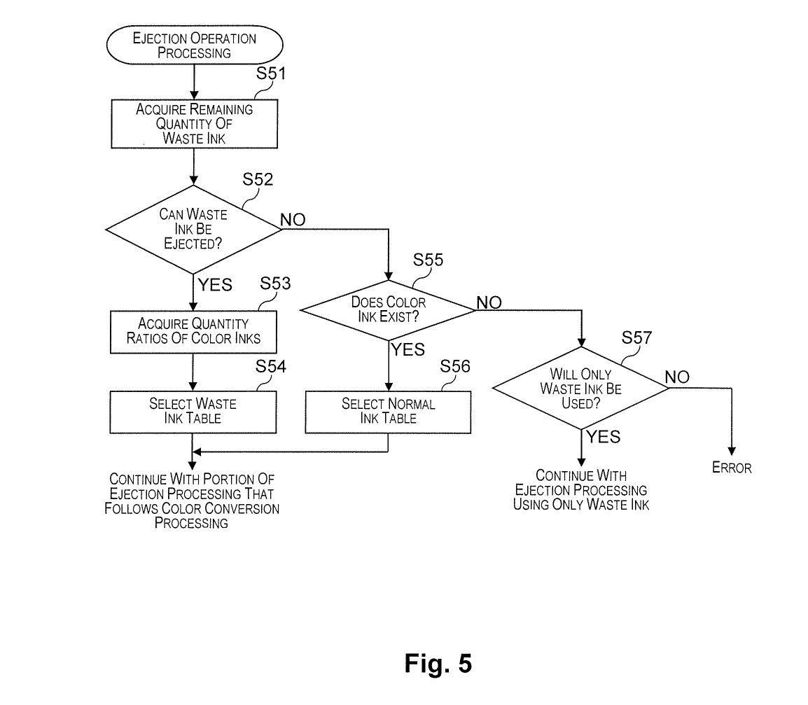

An ejecting operation control executed when the waste ink H is reused will now be explained using FIG. 5. Firstly, in step S51 the control device acquires a remaining quantity of the waste ink. More specifically, the control device reads and acquires the remaining quantity of waste ink H stored in step 44 (of FIG. 4) during the recovery operation control.

In step S52, the control device determines if the waste ink can be used. More specifically, the control device determines if the remaining quantity of the waste ink H acquired in step S51 is equal to or larger than a predetermined threshold value. The threshold value is stored in advance in the ROM 26. It is also acceptable for the liquid ejecting apparatus 100 to be configured such that data indicating a threshold value is submitted by a user through the input unit 31 and stored in the RAM 25 to be used as the threshold value. The threshold value is preferably set to take into account residual ink remaining in the flow passage pipe 16a and the supply pipe 18 through which waste ink H flows as well as in the waste tank 17. Additionally, if a liquid absorbing body that absorbs ink is provided inside the ink cap 16, then an amount of waste ink H that is absorbed by the liquid absorbing body is preferably taken into account too.

If the result of step S52 is Yes (i.e., if it is determined that waste ink can be used), then the control device proceeds to step S53 and acquires quantity ratios of the individual color inks C, M, Y, and K. More specifically, the control device reads and acquires the quantity ratios of the respective color inks C, M, Y, and K stored in step S43 of the recovery operation control. Then, in step S54, the control device selects a waste ink table.

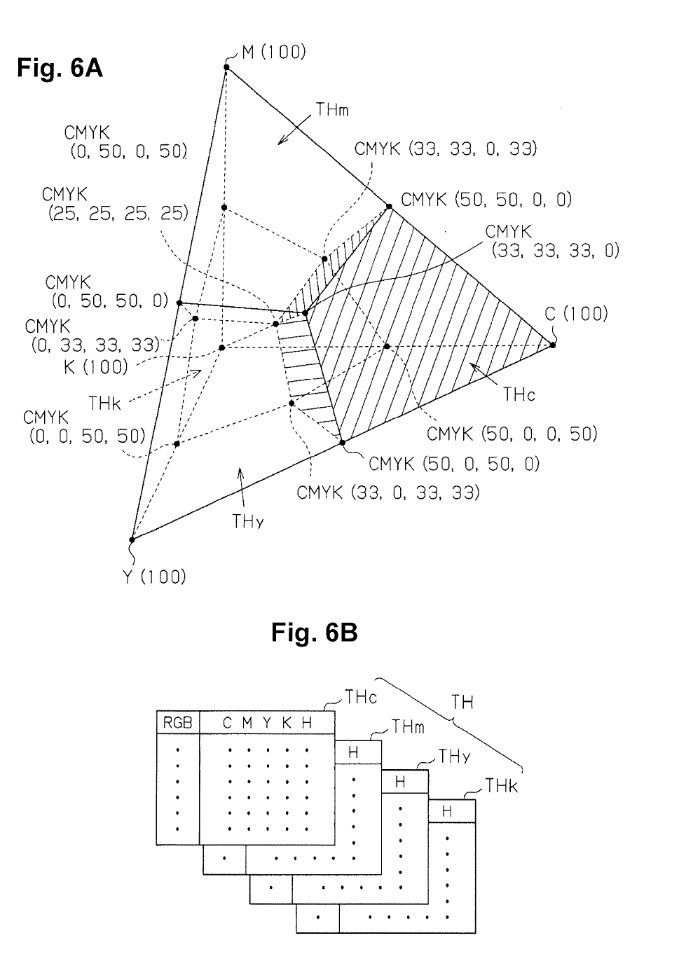

In this embodiment, as shown in FIGS. 6A and 6B, the tables THc, THm, THy, and THk are stored in the RAM 25 as tables TH that include the waste ink H among the inks to be targeted for color conversion processing. The tables THc, THm, THy, and THk correspond to ratio regions of the quantity ratios of the color inks C, M, Y, and K. As shown in FIG. 6A, a region of all possible quantity ratios of the color inks C, M, Y, and K contained in the waste ink H is divided into separate ratio regions (four ratio regions) in each of which the quantity ratio of one of the color inks C, M, Y or K is higher than the quantity ratios of the other color inks. In each of the ratio regions defined in this way, the color characteristics exhibited by the waste ink H are within a range of color characteristics similar to the color characteristics of the color ink whose quantity ratio is highest in that ratio region. Thus, one table THc, THm, THy, or THk is stored in the RAM 25 as a table TH corresponding to each of the four ratio regions.

FIG. 6A is a pictorial view depicting ratio regions of the quantity ratios of the color inks C, M, Y, and K. In the figure, the point CMYK (50, 0, 0, 50), for example, indicates a state in which the quantity ratios of the color ink C and the color ink K are at 50% and the quantity ratios of the color ink M and the color ink Y are at 0%. Similarly, the point CMYK (25, 25, 25, 25) indicates a state in which the quantity ratios of the color inks C, M, Y, and K are equal at 25%. Also, the point CMYK (33, 33, 33, 0) indicates a state in which the quantity ratios of the color inks C, M, and Y are equal at 33% (more precisely 33.33%). Meanwhile, the point C (100) indicates a state in which the quantity ratio of the color ink C is 100%.

As a result, in the waste ink table selection processing (step S54), if, for example, the quantity ratios of the color inks C, M, Y, K in the waste ink H lie in a region (ratio region indicated with hatching in the figure) where the quantity ratio of the color ink C is higher than the quantity ratios of the other color inks M, Y, and K, then the table THc is selected as the table TH. Similarly, the table THm is selected if the quantity ratios are in a region where the quantity ratio of the color ink M is the highest, the table THy is selected if the quantity ratios are in a region where the quantity ratio of the color ink Y is the highest, and the table THk is selected if the quantity ratios are in a region where the quantity ratio of the color ink K is the highest.

After the step S54, the control device proceeds to execute color conversion processing using the selected table TH, the aforementioned halftone processing, and the aforementioned rasterization processing to produce the ejection data Df. The control device then executes ejecting processing. An explanation of this control processing is omitted.

Meanwhile, if the result of step S52 is No, i.e., if it is determined that the waste ink cannot be used, then the control device proceeds to step S55 and determines if there is any color ink. More specifically, through a connection terminal not shown in the figures, the ejecting control section 22 acquires data related to whether or not any of the colored ink C, M, Y, or K remains inside each of the ink cartridges 19 from a memory device (e.g., a memory IC, not shown) provided on the ink cartridges 19.

If the result of step S55 is Yes, i.e., if it is determined that colored ink remains, then the control device proceeds to step S56 and selects a normal ink table. Therefore, a table T tailored to the color inks C, M, Y, and K is selected. Conversely, if the result of step S55 is No, i.e., if is determined that there is no color ink, then the control device proceeds to step S57 and determines if waste ink alone will be used. More specifically, the control device displays content prompting a user to make a decision regarding using waste ink on the display unit 32 and the user inputs data indicating the decision using the input unit 31.

If the result of step S57 is Yes, i.e., if waste ink alone will be used, then the control device proceeds to execute processing for using waste ink alone. In this embodiment, this processing is adopted when it is acceptable if the waste ink H runs out while an ejecting operation is in progress, such as during draft printing in which the image quality is not critical. Meanwhile, if the result is No, i.e., if waste ink alone will not be used, then an error occurs and the ejecting processing is ended.

An example of executing a color conversion that takes color characteristics of the waste ink H into account by using a table TH that includes the waste ink H will now be explained. For now, lets assume that a conversion of some RGB data using a table T that does not include waste ink H yields the CMYK data of C, M, Y, K=20, 30, 40, 10. Meanwhile, if the quantity ratios of the color inks contained in the waste ink H are CMYK (40, 20, 20, 20), then the table THc is used because the color ink C has the highest quantity ratio and the quantity ratios are positioned in a ratio region indicated with hatching in FIG. 6A (which corresponds to a cyan-based hue). Thus, with the table THc, the waste ink H is used instead of the color ink C. Assume, for example, that in order to achieve a color value of 20 for the color ink C, a quantity of the waste ink H corresponding to a value of 50 for the waste ink H is supplied. In such a case, since the quantities of the color inks M, Y, K contained in the waste ink H are one-half the quantity of the color ink C contained, the waste ink supplied will contain quantities of the color inks M, Y, and K corresponding to a value of 10. Therefore, with the table TH, the CMYKH data corresponding to the same RGB data will be C, M, Y, K, H=0, 20, 30, 0, 50. Also, since the color inks in the waste ink H are already mixed, the values of the table TH will be different if equal quantities of the color inks C, M, Y contained in the waste ink H are treated and used as the color ink K.

The effects obtained with this embodiment will now be explained.

(1) Since image data Dg is converted into ejection data Df using a conversion table that is tailored to the respective quantity ratios of the inks C, M, Y, and K contained in the waste ink H, the waste ink H can be used in an appropriate fashion. As a result, even if waste ink H is used to form an image in accordance with the image data Dg, a high quality image can be formed in accordance with the image data Dg by taking the color characteristics of the waste ink H into account.

(2) The quantity ratios of the color inks are divided into ratio regions in which one of the color inks has the highest quantity ratio, and one particular table TH is used with respect to each of the ratio regions. Thus, the number of stored tables TH can be suppressed and a high quality image can be formed in accordance with the image data Dg because the image data Dg is converted using a table TH that is tailored to the color characteristics exhibited by the waste ink H.

(3) The quantity ratios of the color inks C, M, Y, and K contained in the waste ink H change in response to the formation of images and the execution of a recovery operation. Therefore, by using a conversion table that is tailored to the changed quantity ratios of the color inks resulting from execution of a recovery operation, the waste ink can be used appropriately in accordance with its color characteristics.

(4) The quantity ratios of the color inks contained in the waste ink H change in accordance with the quantity of each of the color inks that is discharged during a recovery operation. Therefore, quantity ratios of the color inks are calculated when a recovery operation has been executed. In this way, a conversion table that is tailored to changing quantity ratios of the color inks contained in the waste ink H can be selected and used dynamically in response to recovery operations. As a result, the waste ink H can be used appropriately in accordance with its color characteristics.

(5) If an amount of waste ink H is insufficient, then ejecting in accordance with the image data Dg is not permitted using the waste ink H. As a result, it is possible to prevent the occurrence of a situation in which an image quality is degraded due to a supply of waste ink H running out in the midst of an ejecting operation.

It is acceptable to revise the embodiment explained heretofore to obtain other embodiments.

In the previously explained embodiment, a region of all possible quantity ratios of the color inks C, M, Y, and K contained in the waste ink H is divided into four ratio regions (see FIGS. 6A and 6B) in each of which the quantity ratio of one of the color inks C, M, Y or K is higher than the quantity ratio of the other color inks. However, the invention is not limited to such method. For example, it is acceptable to divide each of the four ratio regions into a plurality of ratio regions. By dividing into a larger number of regions, the amount of variation of the color characteristics of the waste ink H that exists in each of the divided regions can be suppressed and a high quality image can be formed in accordance with the image data Dg.

When each of the four ratio regions is divided further into a plurality of ratio regions, it is preferable to divide the ratio regions such that the regions become smaller as one approaches a point where the quantity ratios of all the color inks C, M, Y, and K contained in the waste ink H are the same (i.e., the point CMYK (25, 25, 25, 25) in FIG. 6A). For example, if it is highly likely that the quantities of the respective color inks discharged during a suction process or a flushing process will be the same, then the differences among the quantity ratios of the color inks C, M, Y, and K contained in the waste ink H will be small. Thus, the variation of the color characteristics of the waste ink actually produced will be smaller and can be expected to hold within a smaller ratio region. Thus, when waste ink H is used, a high quality image can be formed in accordance with the image data Dg.

In the previously explained embodiment, it is preferable for each of the single tables THc, THm, THy, and THk used in the respective ratio regions in which each of the color inks C, M, Y, and K has the highest quantity ratio to be a table TH configured to accommodate quantity ratios that are close to a point where the quantity ratios of all the color inks are the same. If the tables are configured in this way, then when the quantity ratios of the color inks contained in the waste ink H actually produced are close being the same, the number of tables TH used for color conversions can be suppressed and a high quality image can be produced according to the image data Dg because the image data Dg is converted using a table TH tailored to the color characteristics of the waste ink H.

In the previously explained embodiment, it is acceptable if a determination of whether or not the waste ink H can be used (step S52 in FIG. 5) is accomplished based on quantity ratios of the color inks contained in the waste ink H. For example, the apparatus can be configured to determine if the quantity ratio of one color ink is larger than the quantity ratios of the other color inks by a prescribed multiplicative factor (e.g., 2 times as large). In this way, the waste ink H can be used as an ink having a color that is close to the hue of one of the color inks, making it easier to use the waste ink H to form an image in a manner that takes color characteristics into account.

In the previously explained embodiment, it is acceptable if the apparatus is configured to discard the waste ink H discharged during a recover operation without reusing it or conveying it to the waste ink tank 17 from the ink cap 16 if the waste ink H has thickened (an increased viscosity). In such a case, step S44 (FIG. 4) should be configured such that a remaining quantity of the each of the color inks and a remaining quantity of the waste ink H are calculated in a manner that takes into account the quantity of waste ink H that is discarded. In this way, the remaining quantity of waste ink H can be calculated accurately.

In the previously explained embodiments, it is acceptable to switch among conversion tables selectively. For example, there are times when it is feasible to assume that the quantity ratios of the color inks C, M, Y, and K in the waste ink H are substantially fixed and do not change, such as when the recovery operation will always be a simultaneous suction process. In such a case, it is acceptable to use a single conversion table to convert image data Dg to ejection data Df instead of switching the conversion table dynamically in response to recovery operations. In such a case, a single conversion table configured to accommodate the quantity ratios of the color inks resulting from the recovery operation is stored in the RAM 25.

In the previously described embodiment, a determination of a remaining quantity of the waste ink H is accomplished using a threshold value stored in the RAM 25, but the invention is not limited to such a method. It is also acceptable to determine an actual remaining quantity of the waste ink H by detecting it directly. For example, a sensor can be provided to detect a surface level of the waste ink H in the waste ink tank 17.

It is acceptable to configure the previously explained embodiment such that waste ink H is supplied directly to the carriage 14 from the ink cap 16 instead of being collected in a waste ink tank 17. In such case, it is acceptable to provide the carriage with an ink cartridge for storing the waste ink H in the same manner as the other color inks.

Although in the previously explained embodiment the color inks C, M, Y, and K are treated as first liquids and the waste ink H (which is made up of previously discharged color inks C, M, Y, and K) is treated as a second liquid, the invention is not limited to treating a waste liquid as a second liquid. The present invention is applicable so long as the second liquid is made up of a mixture of first liquids. It is also acceptable to use a color ink having a hue other than the hues of the color inks C, M, Y, and K as a first liquid.

Although in the previously explained embodiment the liquid that the liquid ejecting apparatus ejects is ink, it is acceptable for the liquid ejecting apparatus to be configured to eject or otherwise discharge a liquid other than ink. The invention can be applied to various types of liquid ejecting apparatuses, including those equipped with a liquid ejecting head configured to discharge very small-volume liquid droplets. The term “liquid droplet” refers to states of a liquid discharged from the liquid ejecting apparatus that include particle-like droplets, teardrop-like droplets, and droplets with threadlike streaming tails. Furthermore, the liquid can be any material that can be sprayed from a liquid ejecting apparatus. In short, the material can be anything so long as it is in a liquid phase. Examples of materials include a liquid material having a high or low viscosity, a sol, a gel, an inorganic solvent, an organic solvent, a solution, a liquid resin, and a liquid metal (molten metal). It is also acceptable if the material is not entirely a liquid but instead comprises particles of a pigment, metal, or other solid material serving as a functional material that are dissolved, dispersed or mixed in a solvent or other liquid medium. Representative examples of the liquid include ink, as explained in the embodiment, and liquid crystal. Inks are made of a variety of liquid compositions; examples of ink include typical water-based ink, oil-based ink, gel ink, and hot melt ink. Concrete examples of a liquid ejecting apparatus include a liquid ejecting apparatus configured to eject a liquid containing dissolved or dispersed electrode material, color material, or other material used in manufacturing, for example, a liquid crystal display, an EL (electroluminescent) display, a surface emission display, or a color filter Other examples include a liquid ejecting apparatus used as a precision pipette configured to eject a liquid constituting a test specimen, a dye printing apparatus, and a micro dispenser. The present invention can be applied to any of these types of liquid ejecting apparatuses.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A liquid ejecting apparatus adapted to eject a plurality of first liquids each having a different hue and a second liquid including a mixture of the first liquids, the liquid ejecting apparatus comprising:
a liquid ejecting unit provided with a nozzle through which the first liquids and the second liquid are ejected;
a memory section configured to store one conversion table or a plurality of conversion tables for converting image data into ejection data to be used by the liquid ejecting unit to eject at least one of the first liquids and the second liquid so as to form an image; and
a converting section configured to use the conversion table to convert the image data into ejection data indicating quantities of the first liquids and the second liquid that should be ejected from the liquid ejecting unit, the conversion table used by the converting section being determined based on a quantity ratio of the first liquids contained in the second liquid.

2. The liquid ejecting apparatus of claim 1, wherein
the memory section is configured to divide the quantity ratios of the first liquids contained in the second liquid into a plurality of ratio regions and stores one conversion table with respect to quantity ratios lying within each of the ratio regions.

3. The liquid ejecting apparatus of claim 1, further comprising
a liquid quantity computing section configured to compute quantity ratios of the first liquids contained in the second liquid,
the memory section being configured to store a discharged liquid quantity indicating a quantity of the first liquids discharged from the nozzle by a recovery operation configured to recover an ejection function of the nozzle, and to store an ejected liquid quantity indicating a quantity of the second liquid ejected in accordance with the ejection data,
the liquid quantity computing section being configured to acquire the discharged liquid quantities and the ejected liquid quantity stored in the memory section and compute quantity ratios of the first liquids contained in the second liquid, and
the converting section is configured to converts the image data into ejection data based on the computed quantity ratios using the stored conversion table.

4. The liquid ejecting apparatus of claim 3, wherein
the liquid quantity computing section is configured to compute quantity ratios of the first liquids contained in the second liquid when the color liquids making up the first liquids are discharged from the nozzle due to execution of the recovery operation.

5. The liquid ejecting apparatus of claim 3, further comprising
a control section configured to execute a control based on the ejection data such that the first liquids or the second liquid is ejected from the liquid ejecting unit,
the liquid quantity computing section being configured to compute a remaining quantity of the second liquid by subtracting a total of the ejected liquid quantity from a total of the discharged liquid quantity stored in the memory section, and
the control section being configured to execute a control such that the second liquid is not ejected from the liquid ejecting unit if the calculated remaining quantity of the second liquid is not equal to or larger than a threshold value.
